(19) United States
(12) Patent Application Publication
(10) Pub. No.: US 2018/0360015 A1
(43) Pub. Date: Dec. 20, 2018

(54) FISHING-POLE HOLDER AND METHOD

(71) Applicant: John M. Garcia, Victoria, TX (US)

(72) Inventor: John M. Garcia, Victoria, TX (US)

(21) Appl. No.: 15/952,232

(22) Filed: Apr. 12, 2018

Related U.S. Application Data
(60) Provisional application No. 62/522,221, filed on Jun. 20, 2017.

(51) Int. Cl. A01K 97/10

(52) U.S. Cl. CPC A01K 97/10

(57) ABSTRACT

A fishing-pole holder may be useful for supporting a fishing-pole having a rod, a reel, and a handle. The fishing-pole holder includes a stake member, a cradle-mount, a reel-cradle, and a rod-cradle. The stake member may include a shaft having a tapered extremity, such that it may be readily inserted into soil to support the fishing-pole holder. The reel-cradle and the rod-cradle work in combination to support a fishing-pole on the fishing-pole holder in an elevated position, able to be used for fishing.

### CROSS-REFERENCE TO RELATED APPLICATION(S)

The present application is related to and claims priority to U.S. Provisional Patent Application No. 62/522,221 filed Jun. 20, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fishing of existing art and more specifically relates to fishing-pole supports.

### RELATED ART

Many people enjoy fishing. Fishing is the activity of trying to catch fish. Fish are normally caught in the wild. Techniques for catching fish include hand gathering, spearing, netting, angling and trapping. Fishing may also include catching aquatic animals other than fish, such as crustaceans and the like.

When fishing using a fishing-pole, many fishermen prefer to use multiple fishing rods simultaneously to maximize their bounty. Unfortunately, it can be nearly impossible for fishermen to hold onto multiple rods at once, forcing them to set rods on the ground, where they can be damaged or stepped on. Additionally, when a fish bites a line, it is possible for the fish to drag the rod into the water. An efficient alternative is needed.

U.S. Pat. No. 4,866,873 to Kit Van Valkenburg relates to a fishing-pole holder apparatus and method. The described fishing-pole holder apparatus and method includes a fishing-pole holder apparatus including a rod stake member, a slide hammer member and a fishing-pole support bracket. The stake member is provided with an impact end member and an attachment portion for pivotally mounting the fishing-pole support bracket. The impacting slide hammer is mechanically attached to the stake member and is used for imparting a force to the stake member. The fishing-pole support bracket is attachable to the stake member for holding a fishing-pole in a casted position and includes a bent rod piece integrally shaped having a pivotal attachment, a first pole support integral to the pivotal attachment and a second pole support integral to said first pole support. The first and second pole supports cradle the reel end of a fishing-pole while the attachment portion provides horizontal angle flexibility for holding the pole. The slide hammer may add considerable weight to each fishing-pole holder.

### SUMMARY OF THE INVENTION

In view of the foregoing disadvantages inherent in the known fishing-pole support art, the present disclosure provides a novel fishing-pole holder and method. The general purpose of the present disclosure, which will be described subsequently in greater detail, is to provide a fishing-pole holder and method.

A fishing-pole holder is disclosed herein. The fishing-pole holder may be useful for supporting a fishing-pole having a rod, a reel, and a handle. The fishing-pole holder includes a stake member, a cradle-mount, a reel-cradle, and a rod-cradle. The stake member may include a shaft having a tapered extremity, such that it may be readily inserted into soil to support the fishing-pole holder.

The cradle-mount may include a stake-joint, a first cradle-joint, and a second cradle-joint. The cradle-mount may be constructed in such a way that the stake-joint is affixed to the stake member on the opposite end from the tapered extremity of the stake member. The first cradle-joint may be fixed to and may extend from the stake-joint, and the second cradle-joint may likewise be fixed to and may extend from the stake-joint, mirroring the first cradle-joint, such that the cradle-mount is T-shaped. The reel-cradle may have a first leg affixed to the first cradle-joint, and a second-leg affixed to the second cradle-joint, such that the second leg mirrors the first leg. The reel-cradle may also have a reel-holder affixed to the first leg and the second leg, such that the reel-holder joins and arches between the first-leg and the second-leg. The reel-holder may be sized and dimensioned to support the reel of the fishing-pole. The rod-cradle may be fixed to and may extend from the first-leg of the reel-cradle. The rod-cradle may have an indenture which may be used support the shaft of the fishing-pole when the fishing-pole is rested on the fishing-pole holder.

According to another embodiment, a method of supporting a fishing-pole with a fishing-pole holder is also disclosed herein. The method includes providing the fishing-pole holder as described above; inserting the tapered extremity of the stake member into soil; resting the reel of the fishing-pole against an arched portion of the reel-holder; and resting the rod of the fishing-pole on the indenture of the rod-cradle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fishing-pole holder and method, constructed and operative according to the teachings of the present disclosure.

FIG. 1 is a perspective view of the fishing-pole holder during an ‘in-use’ condition, according to an embodiment of the disclosure.

FIG. 2 is a back view of the fishing-pole holder of FIG. 1, according to an embodiment of the present disclosure.

FIG. 3 is an offset back view of the fishing-pole holder of FIG. 1, according to an embodiment of the present disclosure.

FIG. 4A is a side view of the fishing-pole holder of FIG. 1, according to an embodiment of the present disclosure.

FIG. 4B is a top-back perspective view of the fishing-pole holder of FIG. 1, according to an embodiment of the present disclosure.

FIG. 5 is a flow diagram illustrating a method of use for supporting a fishing-pole while fishing, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a fishing-pole support and more particularly to a fishing-pole holder and method as used to improve the ability to support a fishing-pole while fishing.

Generally, the fishing-rod holder is a device for holding a fishing rod in an upright, elevated position, thereby keeping a fishing rod off of the ground, where it could be damaged or stepped on. The fishing-rod holder may accept fishing rods of varying sizes. An intended use of the fishing-rod holder is to allow a fisherman to fish with multiple poles at once by placing multiple poles on multiple fishing-rod holders. The fishing-rod holder is also suitable for supporting a fishing-pole when a fish is hooked on a line of the fishing-pole. The fishing-rod holder may include a tapered stake or bar for easy insertion into the ground, so that the fishing-rod holder is self-supporting. A reel-cradle for accepting a reel of a fishing rod may be welded or otherwise attached to the top end of the bar, preferably at a 60-degree angle between the two. A joint may join the reel-cradle to the stake. In a preferred embodiment, the top section may be constructed using a five-sixteenth inch diameter hot roll round bar bent & shaped into a cradle for the fishing-pole. A rod-cradle may be affixed to the joint opposite to the reel-cradle and may measure approximately three inches in length. The entire holder may measure approximately two inches side to side. Preferably, the reel-cradle includes a bend measuring approximately 30 degrees, raising the end of the reel-cradle to allow the fishing-pole to sit level between the rod-cradle and the reel-cradle when supported by the fishing-pole holder. The rod-cradle may be welded to the reel-cradle portion of the device. The fishing-rod holder may be constructed from a metal or other suitable material. The exact specifications may vary upon manufacturing.

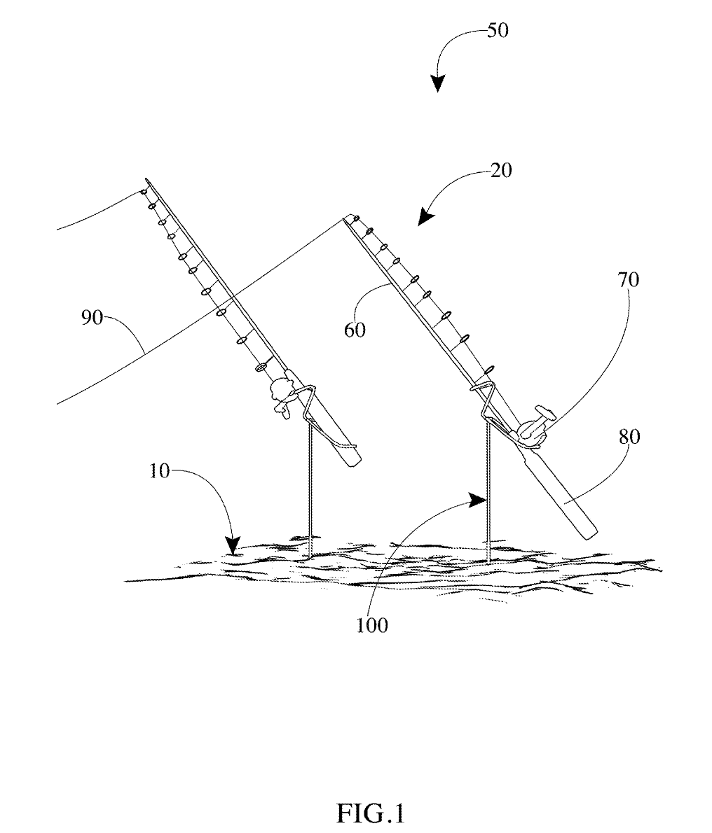

Referring now more specifically to the drawings by numerals of reference, there is shown in FIGS. 1-4, various views of a fishing-pole holder 100.

FIG. 1 shows a fishing-pole holder 100 during an ‘in-use’ condition 50, according to an embodiment of the present disclosure. Here, the fishing-pole holder 100 may be beneficial for use by a user to support a fishing-pole 20. As illustrated, the fishing-pole holder 100 may be configured to be inserted into a soil 10 in order to support fishing-pole 20, fishing-pole 20 being rested upon fishing-pole holder 100. The fishing pole 20 may include a rod 60, a reel 70, a handle 80, and a line 90.

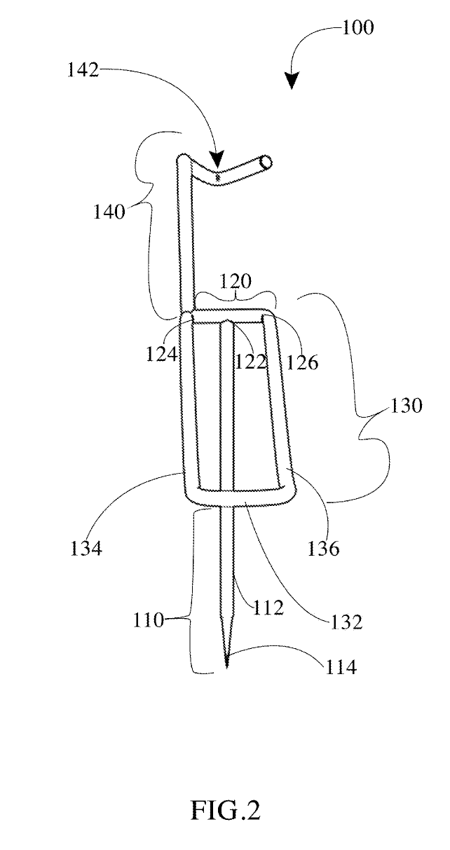

FIG. 2 shows the fishing-pole holder 100 of FIG. 1, according to an embodiment of the present disclosure. The fishing-pole holder 100 may include a stake member 110, cradle-mount 120, reel-cradle 130, and rod-cradle 140. Stake member 110 may include a shaft 112 having tapered extremity 114 configured to be inserted into the soil 10 (FIG. 1). Cradle-mount 120 may include a stake-joint 122, a first cradle-joint 124, and a second cradle-joint 126. As shown, the cradle-mount 120 may have a T-shape, or otherwise be configured to receive a hammer blow and communicate said blow to the stake member 110 so as to aid in driving the stake member 110 into the soil 10.

Reel-cradle 130 may include a first-leg 134, a second-leg 136, and a reel-holder 132. First-leg 134 may be fixed to and extend from the first cradle-joint 124, while second-leg 136 may be fixed to and extend from the second cradle-joint 126, such that second-leg 136 substantially mirrors first-leg 134. Reel-holder 132 may be fixed to and arch between the first-leg 134 and the second-leg 136, with the reel-holder 132 being sized and dimensioned to support the reel 70 (FIG. 1) of the fishing-pole 20 (FIG. 1). Rod-cradle 140 may be fixed to and extend from the first-leg 134 of the reel-cradle 130. Rod-cradle 140 includes an indenture 142, indenture 142 that is configured to receive and support the rod 60 (FIG. 1) of fishing-pole 20.

Stake member 110, cradle-mount 120, reel-cradle 130, and rod-cradle 140 may be constructed of steel, and more specifically may be constructed from metal rod stock. Stake member 110, cradle-mount 120, reel-cradle 130, and rod-cradle 140 may form a unitary body, such that the stake member 110, cradle-mount 120, reel-cradle 130, and rod-cradle 140 are permanently fixed to each other. According to one embodiment, the stake member 110, the cradle-mount 120, the reel-cradle 130, and the rod-cradle 140 may be made from a single bar stock, cut, bent, and welded together so as to include each of their respective features.

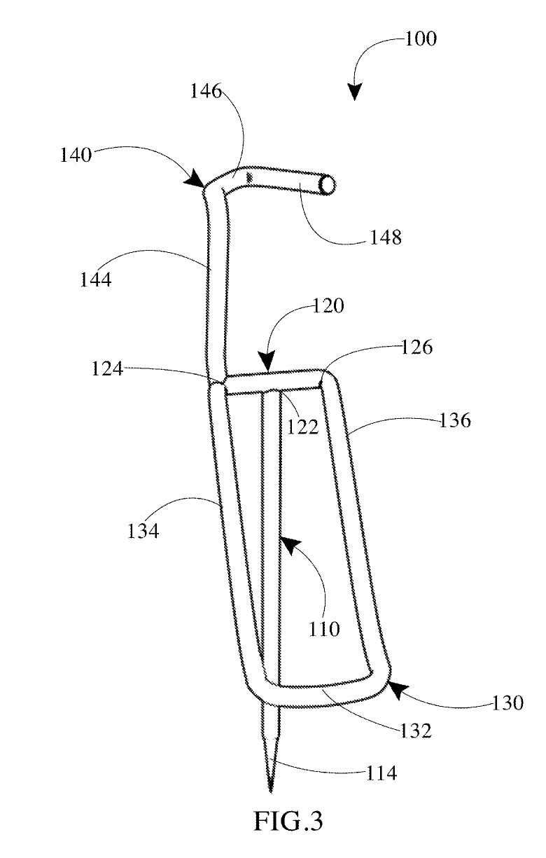

Referring now to FIG. 3, an offset back view of the fishing-pole holder 100 of FIG. 1, according to an embodiment of the present disclosure. As above, the fishing-pole holder 100 may include the stake member 110, the cradle-mount 120, the reel-cradle 130, and the rod-cradle 140. Likewise, the cradle-mount 120 may include the stake-joint 122, the first cradle-joint 124, and the second cradle-joint 126. As shown, the stake-joint 122 of the cradle-mount 120 may be fixed to stake member 110, distal from tapered extremity 114 of stake member 110, while first cradle-joint 124 is fixed to the first-leg 134 of the reel-cradle 130, and the second cradle-joint 126 is fixed to second-leg 136 of the reel-cradle 130. According to one embodiment, the cradle-mount 120 may be welded to stake member 110, the first-leg 134 of reel-cradle 130, and the second-leg 136 of reel-cradle 130.

According to one embodiment, the stake-joint 122 of the cradle-mount 120 may form a substantially perpendicular joint, coupling stake member 110 to cradle-mount 120, for example as a T-joint. Similarly, the first cradle-joint 124 and the second cradle-joint 126 of the cradle-mount 120 may form a substantially perpendicular joint, coupling the reel-cradle 130 to cradle-mount 120 at opposing ends of the cradle-mount 120, for example as two L-joints.

As shown, the rod-cradle 140 may include a first-rod-cradle member 146, a second-rod-cradle member 148, and a third-leg 144. The first-rod-cradle member 146 and the second-rod-cradle member 148 may be affixed to each other, and form the indenture 142. The indenture 142 may be angular, squared, or curved.

The third-leg 144 may be mounted to first-leg 134 of reel-cradle 130 via the cradle-mount 120. Third-leg 144 may be configured to couple the cradle-mount 120 to the first-rod-cradle member 146. Further the third-leg 144 may configured to separate the first-rod-cradle member 146 and the second-rod-cradle member 148 (or the indenture 142) from the reel-cradle 130 and the cradle-mount 120. The third-leg 144 may also be fixed to at least one of first-leg 134 of reel-cradle 130 and cradle-mount 120. The third-leg 144 may be welded to first-leg 134 of reel-cradle 130.

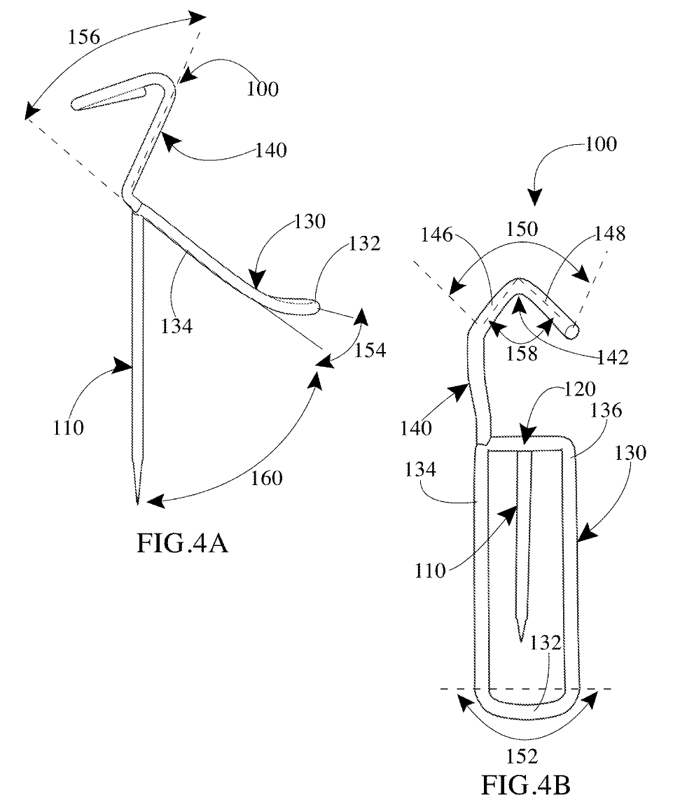

FIG. 4A is a side view of the fishing-pole holder 100 of FIG. 1, according to an embodiment of the present disclosure. As above, the fishing-pole holder 100 may include the stake member 110, the cradle-mount 120, the reel-cradle 130, and the rod-cradle 140. Likewise, the reel-cradle 130 may include two cradle legs (the first-leg 134 and the second-leg 136 (FIG. 4B) that are substantially straight, and the reel-holder 132, which joins the two parallel cradle legs. Likewise, the rod-cradle 140 may include the third-leg 144 that may be fixed to the first-leg 134 and the cradle-mount 120, turn and extend substantially linearly away to join the first-rod-cradle member 146.

As shown, the first-leg 134 of reel-cradle 130, and the second-leg 136 of reel-cradle 130 may be affixed to or otherwise extend from the cradle-mount 120 at a cradle-leg angle 160 (conveniently, measured between the stake member 110 and the plane of the cradle legs 134, 136). According to one embodiment, the cradle-leg angle 160 may measure between ten and ninety degrees, generally giving the reel-cradle 130 a downward to horizontal tilt.

Also as shown, the first-leg 134 and the second-leg 136 of reel-cradle 130 may each be affixed to or otherwise extend from the reel-holder 132 at a reel-lift angle 154 (conveniently, measured as the difference between the largest angle between to stake member 110 and the reel-holder 132, and the cradle-leg angle 160). According to one embodiment, the reel-lift angle 154 may measure between ten and forty-five degrees.

Also as shown, the rod-cradle 140 may be affixed to first-leg 134 of the reel-cradle 130 and the cradle-mount 120 via the third-leg 144 at a third-leg angle 156 (conveniently, measured as the angle between the plane of the cradle legs 134, 136 and the straight extension portion third-leg 144). According to one embodiment, the third-leg angle 156 may measure between ten and ninety degrees.

Together, the reel-lift angle 154, the third-leg angle 156, and the cradle-leg angle 160 may be selected, and/or the reel-cradle 130 and the rod-cradle 140 may be arranged such that the rod 10 is supported in the fishing-pole holder at an angle between ten and forty-five degrees from horizontal.

FIG. 4B is a top-back perspective view of the fishing-pole holder 100 of FIG. 1, according to an embodiment of the present disclosure. First-rod-cradle member 146 and second-rod-cradle member 148 are affixed to each other at indenture-angle 158 between forty-five and ninety degrees. Indenture 142 extends through indenture-arc angle 150, indenture-arc angle measuring between forty-five and ninety degrees. Reel-holder 132 arches between first-leg 134 and second-leg 136 through reel-holder arc angle 152, reel-holder arc angle measuring approximately one-hundred and eighty degrees.

Upon reading this specification, it should be appreciated that, under appropriate circumstances, considering such issues as user preferences, design preference, structural requirements, marketing preferences, cost, available materials, technological advances, etc., other structural arrangements such as, for example, alternate perspectives of bar stock used for construction, etc., may be sufficient.

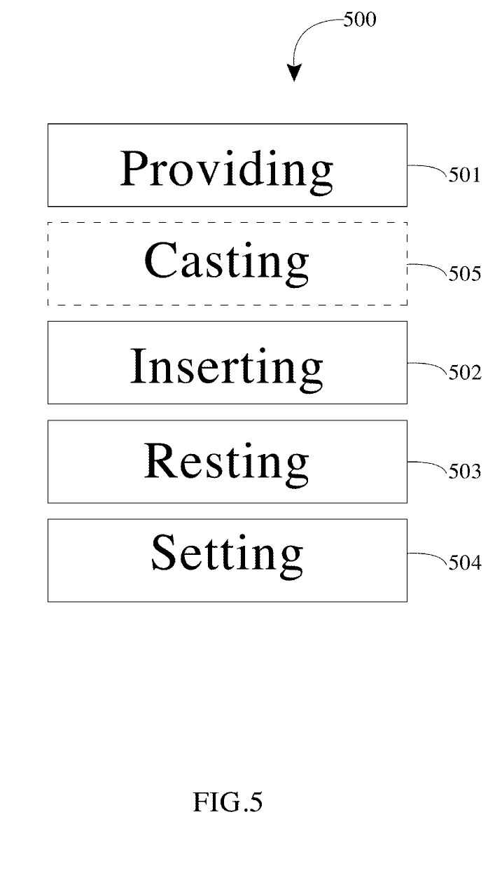

FIG. 5 is a flow diagram illustrating a method for support of a fishing-pole while fishing, according to an embodiment of the present disclosure. In particular, the method 500 for support of a fishing-pole while fishing may include one or more components or features of the fishing-pole holder 100 as described above. As illustrated, the method 500 for supporting a fishing-pole may include the steps of: step one 501, providing a fishing-pole holder support for a fishing-pole as described above, said fishing-pole including a rod, a reel, a handle, and a fishing line, the fishing-pole holder including a stake member including a shaft having a tapered extremity configured to be inserted into soil, a cradle-mount including a stake-joint, a first cradle-joint, and a second cradle-joint, the stake-joint fixed to the stake member distal from the tapered extremity of the stake member, the first cradle-joint fixed to and extending from the stake-joint, the second cradle-joint fixed to and extending from the stake-joint, a reel-cradle including a first-leg fixed to and extending from the first cradle-joint, a second-leg fixed to and extending from the second cradle-joint, the second leg mirroring the first leg, a reel-holder fixed to and arching between the first leg and the second leg, the reel-holder sized and dimensioned to support the reel of the fishing-pole, and a rod-cradle fixed to and extending from the first-leg of the reel-cradle, the rod-cradle including an indenture configured to receive and support the shaft of the fishing-pole. The method 500 may further include step two 502, inserting the tapered extremity of the stake member into soil; step three 503, resting the reel of the fishing-pole against an arched portion of the reel-holder; and step four 504, resting the rod of the fishing-pole on indenture or the rod-cradle. According to one embodiment, the method 500 may further include step five 505, casting a fishing line of the fishing-pole, before the step four 504, resting the fishing-pole upon the fishing-pole holder.

It should be noted that step 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for support of a fishing-pole while fishing, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fishing-pole holder for a fishing-pole, said fishing-pole including a rod, a reel, and a handle, the fishing-pole holder comprising:
a stake member including a shaft having a tapered extremity configured to be inserted into soil;
a cradle-mount including a stake-joint, a first cradle-joint, and a second cradle-joint, the stake-joint fixed to the stake member distal from the tapered extremity of the stake member, the first cradle-joint fixed to and extending from the stake-joint, the second cradle-joint fixed to and extending from the stake-joint;
a reel-cradle including
a first-leg fixed to and extending from the first cradle-joint,
a second-leg fixed to and extending from the second cradle-joint, the second leg mirroring the first leg, and
a reel-holder fixed to and arching between the first leg and the second leg, the reel-holder sized and dimensioned to support the reel of the fishing-pole; and
a rod-cradle fixed to and extending from the first-leg of the reel-cradle, the rod-cradle including an indenture configured to receive and support the rod of the fishing-pole.

2. The fishing-pole holder of claim 1, wherein the stake-joint of the cradle-mount is disposed perpendicularly to the first cradle-joint of the cradle-mount and the second cradle-joint of the cradle-mount.

3. The fishing-pole holder of claim 1, wherein the first-leg of the reel-cradle and the second-leg of the reel-cradle are each affixed to the reel-holder at a reel-lift angle between ten and forty-five degrees.

4. The fishing-pole holder of claim 1, wherein the rod-cradle further includes a third-leg configured a rigid shaft, said third-leg having a first end fixed to the first-leg of the reel-cradle and a second end fixed to the indenture.

5. The fishing-pole holder of claim 1, wherein the rod-cradle is affixed to at least one of the first-leg of the reel-cradle, the second-leg of the reel-cradle, and the cradle-mount and arranged such that the rod is supported in the fishing-pole holder at an angle between ten and forty-five degrees from horizontal.

6. The fishing-pole holder of claim 1, wherein the indenture of the rod-cradle includes a first-rod-cradle member and a second-rod-cradle member affixed to each other at an indenture-angle between forty-five and ninety degrees.

7. The fishing-pole holder of claim 1, wherein the indenture of the rod-cradle is curved and extends through an indenture-arc angle between forty-five and ninety degrees.

8. The fishing-pole holder of claim 1, wherein the reel-holder arcs between the first leg and the second leg through a reel-holder arc angle of approximately one-hundred and eighty degrees.

9. The fishing-pole holder of claim 1, wherein the stake member, the cradle-mount, the reel-cradle, and the rod-cradle are made of steel.

10. The fishing-pole holder of claim 1, wherein the stake member, the cradle-mount, the reel-cradle, and the rod-cradle are constructed from metal rod stock.

11. The fishing-pole holder of claim 10, wherein the rod-cradle is welded to the first-leg of the reel-cradle.

12. The fishing-pole holder of claim 11, wherein the cradle-mount is welded to the stake member, the first-leg of the reel-cradle, and the second-leg of the reel-cradle.

13. The fishing-pole holder of claim 1, wherein the stake member, the cradle-mount, the reel-cradle, and the rod-cradle comprise a unitary body, such that the stake member, the cradle-mount, the reel-cradle, and the rod-cradle are permanently fixed to each other.

14. The fishing-pole holder of claim 1, wherein the first-leg of the reel-cradle and the second-leg of the reel-cradle are affixed to the cradle-mount at a cradle-leg angle, relative to the stake member, measuring between ten and ninety degrees.

15. The fishing-pole holder of claim 1, wherein the rod-cradle is also fixed to at least one of the second-leg of the reel-cradle and the cradle-mount.

16. The fishing-pole holder of claim 1, wherein the fishing-pole holder is painted.

17. A soil-insertable fishing-pole holder for a fishing-pole, said fishing-pole including a rod, a reel, and a handle, the soil-insertable fishing-pole holder comprising:
a stake member including a shaft having a tapered extremity configured to be inserted into soil,
a cradle-mount including a stake-joint, a first cradle-joint, and a second cradle-joint, the stake-joint fixed to the stake member distal from the tapered extremity of the stake member, the first cradle-joint fixed to and extending from the stake-joint, the second cradle-joint fixed to and extending from the stake-joint,
a reel-cradle including
a first-leg fixed to and extending from the first cradle-joint,
a second-leg fixed to and extending from the second cradle-joint, the second leg mirroring the first leg, and
a reel-holder fixed to and arching between the first leg and the second leg, the reel-holder sized and dimensioned to support the reel of the fishing-pole, and
a rod-cradle fixed to and extending from the first-leg of the reel-cradle, the rod-cradle including an indenture configured to receive and support the rod of the fishing-pole;
wherein the stake-joint of the cradle-mount is disposed perpendicularly to the first cradle-joint of the cradle-mount and the second cradle-joint of the cradle-mount;
wherein the first-leg of the reel-cradle and the second-leg of the reel-cradle are each affixed to the reel-holder at a reel-lift angle between ten and forty-five degrees;
wherein the rod-cradle further includes a third-leg configured a rigid shaft, said third-leg having a first end fixed to the first-leg of the reel-cradle and a second end fixed to the indenture;
wherein the rod-cradle is affixed to the first-leg of the reel-cradle and the second-leg of the reel-cradle at a rod-cradle angle between ten and forty-five degrees;
wherein the indenture of the rod-cradle includes a first-rod-cradle member and a second-rod-cradle member affixed to each other at an indenture-angle between forty-five and ninety degrees;
wherein the indenture of the rod-cradle is curved and extends through an indenture-arc angle between forty-five and ninety degrees;
wherein the reel-holder arcs between the first leg and the second leg through a reel-holder arc angle of approximately one-hundred and eighty degrees;
wherein the stake member, the cradle-mount, the reel-cradle, and the rod-cradle are constructed from metal rod stock;
wherein the rod-cradle is welded to the first-leg of the reel-cradle;
wherein the cradle-mount is welded to the stake member, the first-leg of the reel-cradle, and the second-leg of the reel-cradle;
wherein the stake member, the cradle-mount, the reel-cradle, and the rod-cradle comprise a unitary body, such that the stake member, the cradle-mount, the reel-cradle, and the rod-cradle are permanently fixed to each other;
wherein the first-leg of the reel-cradle and the second-leg of the reel-cradle are affixed to the cradle-mount at a cradle-leg angle, relative to the stake member, measuring between ten and ninety degrees; and
wherein the rod-cradle is also fixed to at least one of the second-leg of the reel-cradle and the cradle-mount.

18. A method of supporting a fishing-pole, the method comprising the steps of:
providing a fishing-pole holder support for a fishing-pole, said fishing-pole including a rod, a reel, a handle, and a fishing line, the fishing-pole holder including:
a stake member including a shaft having a tapered extremity configured to be inserted into soil,
a cradle-mount including a stake-joint, a first cradle-joint, and a second cradle-joint, the stake-joint fixed to the stake member distal from the tapered extremity of the stake member, the first cradle-joint fixed to and extending from the stake-joint, the second cradle-joint fixed to and extending from the stake-joint,
a reel-cradle including
a first-leg fixed to and extending from the first cradle-joint,
a second-leg fixed to and extending from the second cradle-joint, the second leg mirroring the first leg, and
a reel-holder including an arched portion, the reel-holder fixed to and arching between the first leg and the second leg, the reel-holder sized and dimensioned to support the reel of the fishing-pole, and
a rod-cradle fixed to and extending from the first-leg of the reel-cradle, the rod-cradle including an indenture configured to receive and support the shaft of the fishing-pole;
inserting the tapered extremity of the stake member into a soil;
resting the reel of the fishing-pole against the arched portion of the reel-holder; and
resting the rod of the fishing-pole on the indenture of the rod-cradle.

19. The method of claim 18, further comprising the step of casting a fishing line of the fishing-pole, before the resting the fishing-pole upon the fishing-pole holder.
